(19) United States
(12) Patent Application Publication
(10) Pub. No.: US 2019/0071961 A1
(43) Pub. Date: Mar. 7, 2019

(54) METHOD FOR CLEANING FLOWBACK WATER IN OIL AND GAS PRODUCTION OPERATIONS

(71) Applicant: AMCOL INTERNATIONAL CORPORATION, Hoffman Estates, IL (US)

(72) Inventor: Jarid Byron HUGONIN, Lafayette, LA (US)

(21) Appl. No.: 16/147,116

(22) Filed: Sep. 28, 2018

Related U.S. Application Data
(63) Continuation of application No. PCT/US2016/025168, filed on Mar. 31, 2016.

(51) Int. Cl. E21B 43/34; B01D 63/10; C02F 1/00; C02F 1/44

(52) U.S. Cl. CPC E21B 43/34; B01D 63/10; E21B 43/16; C02F 1/44; C02F 1/004

(57) ABSTRACT

A method for cleaning flowback water in oil or gas production operations includes passing the flowback water tangentially across a membrane arranged spirally around a collection pipe, and allowing water contained in the flowback water to collect in the collection pipe while excluding certain constituents of the flowback water from the collection pipe.

### CROSS-REFERENCE TO RELATED APPLICATIONS

This application is a continuation of International Application No. PCT/US2016/025168 filed Mar. 31, 2016, which is hereby incorporated by reference.

### FIELD

The invention relates, in general, to a method for cleaning flowback water in oil and gas production operations.

### BACKGROUND

Water is often used in oil and gas production operations to extend existing channels in subterranean rock formations that contain oil and/or natural gas. After the water is pumped into the subterranean rock formations, a significant amount flows back to the earth's surface. This liquid is commonly referred to as “flowback” or “flowback water.” Flowback water may contain a combination of the water, clays, chemical additives, dissolved metal ions, salts, dissolved solids, oil, grease, other hydrocarbons, organic contaminant molecules, and/or other constituents. The flowback water comes out of the ground over a period of several days or a few months after it has been pumped into the ground.

The liquid flowing to back out of the earth's surface may transition from flowback water to produced water. The term “produced water” refers to liquid that is naturally occurring in and around subterranean rock formations. Produced water typically flows to the surface, together with the produced oil and/or natural gas, throughout the lifespan of the well.

The flowback water is cleaned to mitigate environmental impacts. Various methods have been used for cleaning. For example, an adsorption process has been used. Adsorption refers to the adhesion of atoms, ions, or molecules to a surface. CrudeSorb(R) is a type of adsorption media which has been used to remove oil, grease, and other organic contaminant molecules from flowback water.

There is a continuing need for other methods for cleaning flowback water, as the composition of flowback water may vary from one well to another.

### SUMMARY

Briefly and in general terms, the present invention is directed to a method for cleaning flowback water in oil or gas production operations.

In aspects of the present invention, a method comprises pumping a liquid into a subterranean formation, allowing the liquid to return above ground together with constituents to be removed from the liquid, and removing at least some of the constituents from the liquid. Removal is performed by passing the liquid tangentially across a membrane arranged spirally around a collection pipe, and allowing the liquid to collect in the collection pipe while excluding the constituents from the collection pipe.

The features and advantages of the invention will be more readily understood from the following detailed description which should be read in conjunction with the accompanying drawings.

### BRIEF DESCRIPTION OF THE DRAWINGS

FIG. 1 is a schematic diagram showing an exemplary system for cleaning flowback water.

FIG. 2 is a schematic section view showing an exemplary settling chamber of the system of FIG. 1.

FIG. 3 is a schematic section view showing an exemplary physical filter of the system of FIG. 1

FIG. 4 is a schematic isomentric view showing an exemplary spiral filter of the system of FIG. 1.

FIG. 5 is a partial detail view showing an exemplary membrane and feed spacer of the spiral filter of FIG. 4.

FIG. 6 is a partial section showing the membrane and feed spacer of the spiral filter of FIG. 4.

FIG. 7 is a flow diagram showing an exemplary method for cleaning flowback water.

### DETAILED DESCRIPTION OF EXEMPLARY EMBODIMENTS

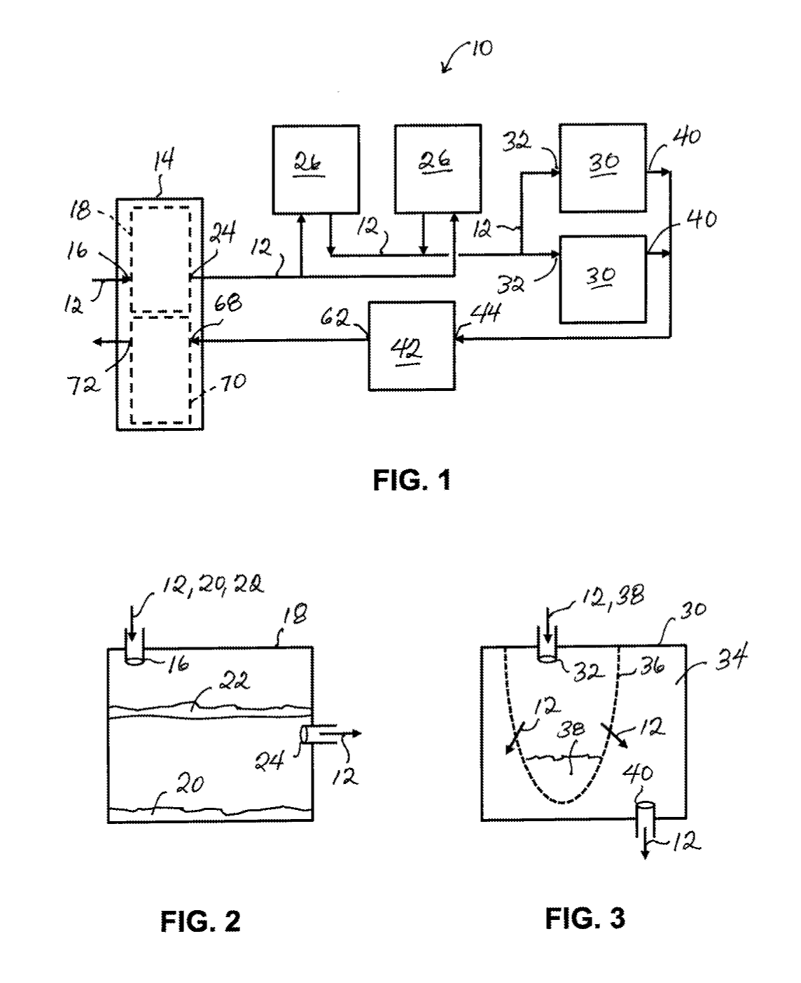

Referring now in more detail to the exemplary drawings for purposes of illustrating exemplary aspects of the invention, wherein like reference numerals designate corresponding or like elements among the several views, there is shown in FIG. 1 an exemplary system 10 for cleaning flowback water 12 in oil or natural gas production operations. Flowback water may contain a combination of the water, clays, chemical additives, dissolved metal ions, salts, dissolved solids, oil, grease, other hydrocarbons, organic contaminant molecules, and/or other constituents.

System 10 includes weir box 14 in which flowback water 12 is collected. The flowback water 12 typically comes from a well into which water was previously pumped. Arrows in FIG. 1 indicate the flow direction of flowback water 12 between various components of system 10 which will be described below. The flow is achieved with pipes that fluidly connect those components.

As shown in FIG. 2, flowback water 12 enters first weir inlet 16 of weir box 14. Inlet 16 opens to settling chamber 18 where constituents of flowback water 12 may be collected. For example, as shown in FIG. 2, relatively heavy constituents 20 such as sand, soil, and/or undissolved solids may settle to the bottom of settling chamber 18 where those constituents may be drained out. The relatively heavy constituents 20 may be those which have a specific density that is greater than that of pure water. Relatively light constituents 22 such as grease and hydrocarbons may float to the top surface of flowback water 12 where they may be bled off. The relatively light constituents 22 may be those which have a specific density that is less than that of pure water. The remaining flowback water 12 is pumped out of weir box 14 through first weir outlet 24. This is accomplished by pumps 26 (FIG. 1) connected to outlet 24. Pumps 26 force flowback water 12 through physical filters 30.

As shown in FIG. 3, flowback water 12 enters filter inlet 32 of physical filter 30. Flowback water 12 flows through physical filter 30 due to hydraulic pressure provided by pumps 26. Filter inlet 32 opens into filter chamber 34 containing filter medium 36 configured to trap constituents of flowback water 12. Filter chamber 34 is a pressure vessel capable of receiving flowback water 12 under high pressure from pumps 26. Filter inlet 32 is located on one side of filter medium 36. Filter medium 36 includes pores through which liquids of flowback water 12 may pass. The pores are sized to prevent passage of certain constituents 38 through filter medium 36. For example, filter medium 36 can be a sock filter made of a fine mesh of material. Constituents 38, such as small solid particles entrained in the liquid pumped out of weir outlet 24, are trapped and collected at one side of filter medium 36. Filter outlet 40 is located at the other side of filter medium 36. Filter medium 36 separates filter inlet 32 from filter outlet 40 such that flowback water 12 must pass through filter medium 36 in order to reach filter outlet 40. Flowback water 12 is propelled under pressure from filter outlet 40 to spiral filter 42 (FIG. 1).

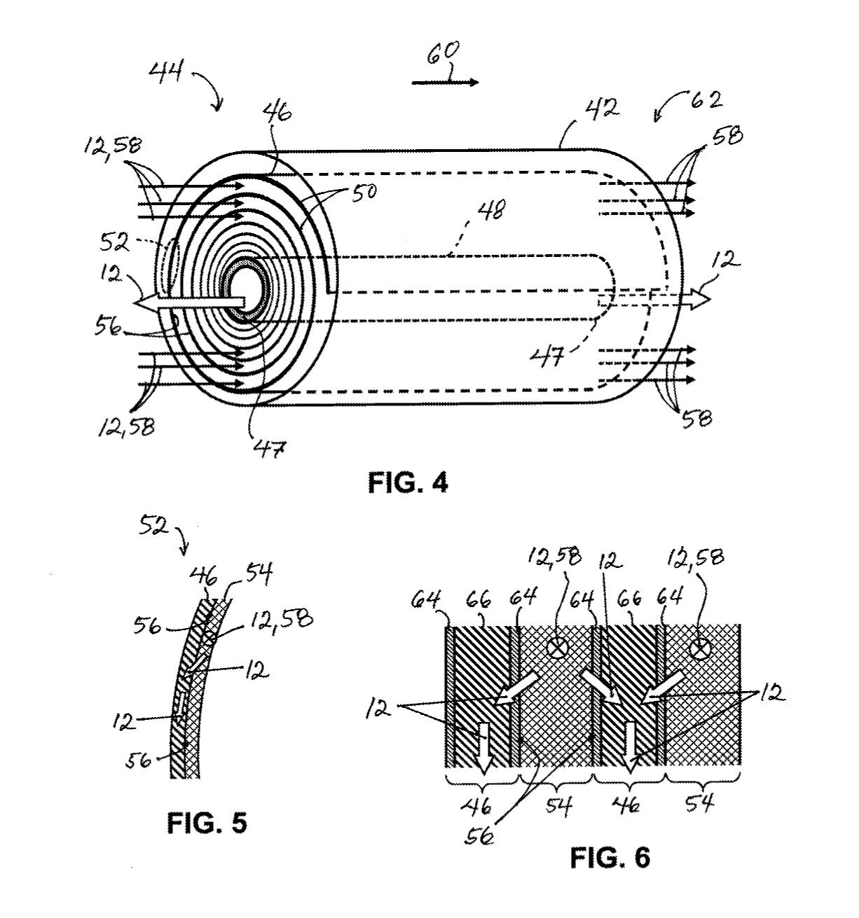

As shown in FIG. 4, flowback water 12 enters first end 44 of spiral filter 42. Flowback water 12 flows through spiral filter 42 due to hydraulic pressure provided by pumps 26. Spiral filter 42 includes membrane 46 that is wound around perforated pipe 48. Membrane 46 is a sheet of material comprising multiple layers, as will be described later. Edges 50 of membrane 46 form a spiral that converges toward perforated pipe 48. Membrane 46 is shown loosely wound around perforated pipe 48 for illustration purposes only. In use, membrane 46 is typically tightly wound around perforated pipe 48. Portion 52 of membrane 46 in FIG. 4 is enlarged in FIG. 5.

As shown in FIG. 5, flowback spacer 54 is located adjacent to membrane 46. Flowback feed spacer 54 is a sheet of material, for example a mesh sheet, that keeps curved surfaces 56 of membrane 46 spaced apart from each other, thereby creating a gap between curved surfaces 56. Within feed spacer 54, the fibers of the mesh sheet are sufficiently thick and spaced apart to allow flowback water 12 and its constituents 58 to travel within and through the mesh sheet. Flowback water 12 and constituents 58 travel within feed spacer 54 in a tangential direction across curved surfaces 56 of membrane 46.

In FIG. 5, the circle with a cross (“crossed circle”) indicates that the direction of travel of flowback water 12 generally goes into (generally perpendicular to) the plane of the page. The crossed circle symbol is also used in FIG. 6. The direction indicated by the crossed circles corresponds to arrow 60 at the top of FIG. 4. Arrow 60 indicates the predominant flow direction of flowback water 12 which enters first end 44 of spiral filter 42. The concentration of constituents 58 increases as the flow progresses through spiral filter 42 along the direction of arrow 60. The amount of water in the flow becomes reduced, and a high concentration of constituents 58 exits second end 62 (FIG. 4) of spiral filter 42.

FIG. 6 is an enlarged section view of membrane 46 and feed spacer 54. Both membrane 46 and feed spacer 54 are spirally wound around perforated pipe 48 (FIG. 4), which results in an alternating arrangement of membrane 46, feed spacer 54, membrane 46, feed spacer 54, and so on. Membrane 46 includes two barrier layers 64 and transport layer 66 sandwiched between barrier layers 64. The molecular arrangement of barrier layers 64 creates very small pores that allow water molecules, under pressure provided by pumps 26 (FIG. 1), to pass through the pores and into transport layer 66 while keeping constituents 58 (which have molecules larger than water molecules) out of transport layer 66. This effect removes pure water from the flow within feed spacer 54. Constituents 58 remain in feed spacer 54 and continue to travel axially (as indicated by the crossed circles corresponding to arrow 60 of FIG. 4) outside of membrane 46.

Flowback water 12, which has a greater concentration of pure water and is without constituents 58, travels within transport layer 66. Constituents 58 that are removed from flowback water 12 may vary depending on the molecular arrangement of barrier layers 64. For example, the molecular arrangement of barrier layers 64 may be selected to remove salts, metal ions, organic contaminant molecules, dissolved hydrocarbons, and/or chemical additives. The removed constituents exit second end 62 (FIG. 4) of spiral filter 42.

Flowback water 12 within transport layer 66 is conveyed by transport layer 66 to perforated pipe 48 (FIG. 4). Again, this flowback water has a greater amount of pure water than the flowback water that initially entered first end 44 of spiral filter 42. Cleaner flowback water 12 collects within perforated pipe 48 and remains separated from constituents 58 which have been blocked by barrier layers 64. Cleaner flowback water 12 flows out of one or both ends 47 of collection pipe 48 as shown in FIG. 4.

Several spiral filters may be used instead of a single spiral filter. The spiral filters may be arranged in parallel where the flowback water coming from physical filters 30 is divided into two or more branches. Each branch leads to its own spiral filter. Additionally, each branch may include two or more spiral filters arranged in series, wherein the collection pipe of an upstream spiral filter feeds flowback water between membranes of a downstream spiral filter.

Referring again to FIG. 1, flowback water 12 flows from perforated pipe 48 of spiral filter 42 to second weir inlet 68 of weir box 14. Inlet 68 opens to holding chamber 70 within weir box 14. Holding chamber 70 may allow for chemical treatment, sparging, and/or other water polishing techniques known in the art to remove additional constituents before flowback water 12 is discharged out of second weir outlet 72. The additional constituents may include dissolved gas, chemicals, and microscopic particles.

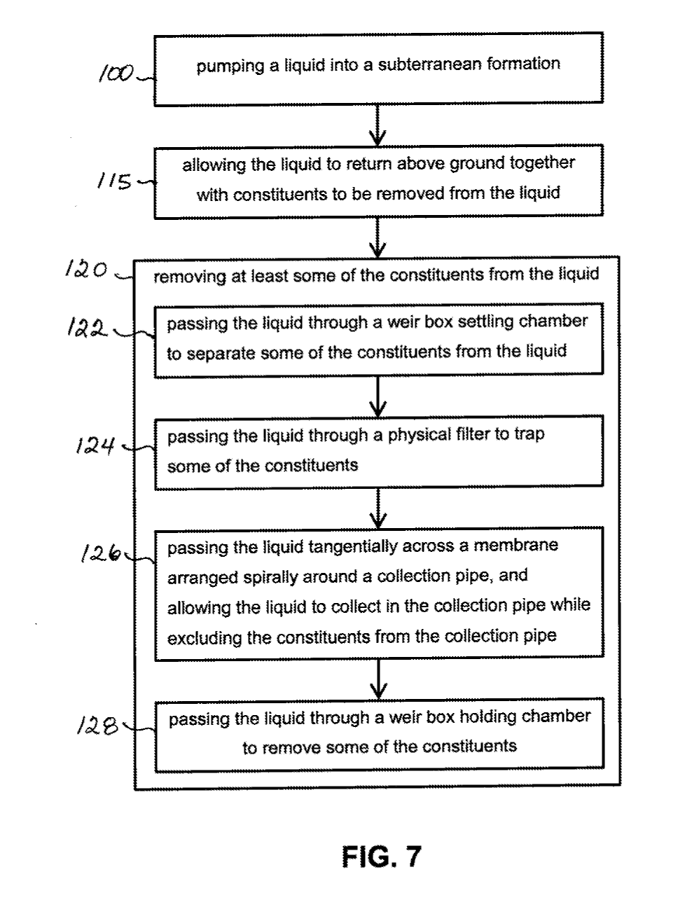

FIG. 7 depicts an exemplary method for cleaning flowback water in oil or natural gas production operations. Although the method is described with reference to components of system 10, it is to be understood that the method may be performed using other systems for cleaning flowback water.

At block 100, liquid is pumped into a subterranean formation containing or believed to contain oil and/or natural gas. This can be accomplished by pumping the liquid into a wellhead. Pumping may be performed to extend existing channels in the subterranean formation or to create new channels therein. The liquid pumped into the ground includes water. The liquid optionally includes constituents that are to be removed from the water at a later time.

At block 115, the liquid which was pumped into the subterranean formation is allowed to return above ground. The liquid which returns above ground includes constituents, some of which may have been present in the liquid when the liquid was initially pumped into the subterranean formation. Some of the constituents may not have been present in the liquid when the liquid was pumped into the subterranean formation.

At block 120, at least some of the constituents present in the liquid are removed. Removal may be performed to yield water that satisfies predetermined limits on the amount of constituents that may be present in the flowback water. Removal includes any one or a combination of processes of blocks 122, 124, 126, and 128.

At block 122, the liquid which has returned above ground is passed through a weir box settling chamber (for example, settling chamber 18). The weir box settling chamber is designed to allow separation of some of the constituents from the liquid by relying, at least in part, on the specific density of the constituent relative to pure water. The constituents that are separated may include any of sand, soil, undissolved solids, grease, and hydrocarbons. Thus, liquid which exits the weir box settling chamber is cleaner than when it entered.

At block 124, the liquid which has returned above ground is passed through a physical filter (for example, physical filter 30). This may be accomplished by pumping the liquid from the weir box settling chamber into the physical filter. The physical filter is designed to allow some of the constituents in the water to be trapped by a filter medium having pores that prevent passage of the constituents. The constituents that are trapped may include solid particles entrained in the liquid. Thus, liquid which exits the physical filter is cleaner than when it entered.

At block 126, the liquid which has returned above ground is passed tangentially across a membrane arranged spirally around a collection pipe. This may be performed by pumping liquid from the physical filter of block 124 into a spiral filter (for example, spiral filter 42). The physical filter of block 124 and settling chamber 18 of block 122 may remove constituents, such as solid particles and oil, that may clog or degrade membrane. To prevent clogging or degradation of the membrane, filtering using other techniques, in addition to or as alternatives to the physical filter of block 124 and settling chamber 18 of block 122, may be performed on the liquid before it is passed tangentially across the membrane.

The membrane is designed to allow pure water to pass into the membrane while keeping some of the constituents out of the membrane. Liquid comprising pure water and potentially other constituents that were able to pass into the membrane are conveyed by the membrane to the collection pipe. The liquid collects in the collection pipe, where it is later drained or flushed out under pressure.

At block 128, the liquid which has returned above ground is passed through a weir box holding chamber (for example, holding chamber 70). This may be accomplished by pumping liquid from the collection pipe of block 126 into the holding chamber. The holding chamber is designed to allow removal of some of the constituents in the water. Removal may be performed by chemical treatment, sparging, and/or other water polishing techniques known in the art.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

1. A method for cleaning flowback water in oil or gas production operations, the method comprising:
pumping a liquid into a subterranean formation;
allowing the liquid to return above ground together with constituents to be removed from the liquid;
removing at least some of the constituents from the liquid by:
passing the liquid tangentially across a membrane arranged spirally around a collection pipe, and
allowing the liquid to collect in the collection pipe while excluding the constituents from the collection pipe.

2. The method claim 1, wherein the membrane includes barrier layers and a transport layer sandwiched between the barrier layers, and the barrier layers have a molecular arrangement that allow water molecules to pass through the barrier layers and prevents some molecules larger than water molecules from passing through the barrier layer.

3. The method of claim 2, wherein the constituents includes any of salts, metal ions, organic contaminant molecules, dissolved hydrocarbons, and chemical additives, any one or a combination of which constituents are blocked by the barrier layers from entering the collection pipe.

4. The method of claim 1, wherein the constituents include solid particles and oil, and removing the constituents from the liquid includes filtering the solid particles and oil out of the liquid before passing the liquid tangentially across the membrane.

5. The method of claim 1, wherein removing the constituents from the liquid includes passing the liquid through a weir box settling chamber before passing the liquid tangentially across the membrane.

6. The method of claim 5, wherein the constituents includes any of sand, soil, undissolved solids, grease, and hydrocarbons, any one or a combination of which constituents separate from the liquid while in the weir box, the separation occurring due to specific density of the constituent relative to pure water, and wherein after the separation occurs, additional or other constituents remain in the liquid and are later excluded from the collection pipe.

7. The method of claim 1, wherein removing the constituents from the liquid includes passing the liquid through a physical filter before passing the liquid tangentially across the membrane.

8. The method of claim 7, wherein the constituents include solid particles entrained in the liquid, the physical filter traps the solid particles, and wherein after the solid particles are trapped, additional or other constituents remain in the liquid and are later excluded from the collection pipe.

9. The method of claim 1, wherein removing the constituents from the liquid includes passing the liquid through a weir box holding chamber after allowing the liquid to collect in the collection pipe.

10. The method of claim 9, wherein after allowing the liquid to collect in the collection pipe, the liquid includes additional constituents, the additional constituents include any of dissolved gas, chemicals, and microscopic particles, any one or a combination of which additional constituents are removed from the liquid in the weir box holding chamber.

11. The method of claim 1, wherein pumping the liquid into a subterranean formation incudes pumping the liquid into a wellhead.

12. The method of claim 11, wherein the liquid pumped into the subterranean formation includes water.
